(19) United States
(12) Patent Application Publication
(10) Pub. No.: US 2023/0419094 A1
(43) Pub. Date: Dec. 28, 2023

(54) RESERVOIR ELEMENT

(71) Applicant: TDK CORPORATION, Tokyo (JP)

(72) Inventor: Kazuki NAKADA, Tokyo (JP)

(73) Assignee: TDK CORPORATION, Tokyo (JP)

(21) Appl. No.: 18/039,561

(22) PCT Filed: Dec. 3, 2020
(86) PCT No.: PCT/JP2020/044978

§ 371 Date: May 31, 2023

(51) Int. Cl. G06N 3/065; G06N 3/044; G06N 3/084

(52) U.S. Cl. CPC G06N 3/065; G06N 3/044; G06N 3/084

(57) ABSTRACT

A reservoir element according to an embodiment is a reservoir element including a ring-shaped reservoir constituted by a single nonlinear element and a plurality of delay elements, in which the nonlinear element has a nonlinear modulation function, the nonlinear element being controllable by a time-varying parameter capable of dynamically changing the nonlinear modulation function, and the reservoir element includes a control unit that controls the time-varying parameter in accordance with a time series having a cycle corresponding to the number of stages of the nonlinear element and the delay elements.

### TECHNICAL FIELD

The present invention relates to a reservoir element.

### BACKGROUND ART

A neuromorphic device is an element that imitates the human brain through a neural network. A neuromorphic device artificially imitates a relationship between neurons and synapses in a human brain.

A neuromorphic device includes, for example, chips (neurons in a brain) disposed in layers and transmission means (synapses in the brain) for connecting the chips. The neuromorphic device increases a correct answer rate of a problem by the learning of the transmission means (synapses). The learning is to find knowledge that can be used in the future from information, and neuromorphic device weights input data.

A recurrent neural network is known as one of neural networks. A recurrent neural network can handle nonlinear time-series data. Nonlinear time-series data is data of which the value changes over time, and a stock price is an example. The recurrent neural network can process time-series data by returning processing results with neurons in a latter layer to neurons in a previous layer.

Reservoir computing is one means for realizing a recurrent neural network. Reservoir computing performs recursive processing by making signals interact with each other. Reservoir computing imitates, for example, the operation of the cerebellum, and performs recursive data processing, data conversion (for example, coordinate conversion), and the like.

As described above, reservoir computing has been proposed as machine learning for time-series signals. This machine learning is also expected to be applied to edge learning.

A time-series signal is stream data changing every moment, and can be used to obtain a sign of a mechanical failure or a biological disease by measuring and analyzing sensor data indicating, for example, the state of a facility operating in a factory and a process and biological signals obtained from a wearable device.

Attempts have been made to physically implement the concept of reservoir computing on an actual element. Various device structures have been proposed as reservoirs computing for engineering physical implementation.

An implementation of the concept of reservoir computing as an actual element is hereinafter referred to as a reservoir element.

As a specific example, a neuromorphic device using a spin torque oscillator (STO) element as a chip (neuron) has been developed.

Non-Patent Document 1 and Non-Patent Document 2 propose reservoir computing of a delayed feedback one-dimensional ring topology and its implementation method (see Non-Patent Document 1 and Non-Patent Document 2).

Non-Patent Document 3 proposes a heuristic method of statistically randomly distributing parameters in reservoir computing (see Non-Patent Document 3).

### CITATION LIST

### Non-Patent Document

[Non-Patent Document 1]
H. Jaeger and H. Haus. Science, vol. 304, no. 5667, pp. 78-80, 2004
[Non-Patent Document 2]
L. Appeltant, Reservoir computing based on delay-dynamical systems, 2012
[Non-Patent Document 3]
G. Tanaka et al. Exploiting Heterogeneous Units for Reservoir Computing with Simple Architecture, 187-194, (2016) doi:10.1007/978-3-319-46687-3_20

### SUMMARY OF INVENTION

### Technical Problem

As described above, various proposals have been made to implement reservoirs as physical devices.

However, although it has been suggested that a network structure that improves prediction performance of a reservoir will be a small world, there is a problem that it is difficult to realize the reservoir as an electronic device. For example, in a case where the reservoir is mounted as an integrated electronic device, there are problems of wiring complexity and an element footprint, and it has not been put to practical use.

The present invention has been made in view of the above circumstances, and provides a reservoir element capable of improving nonlinear conversion performance of a reservoir and allowing the reservoir to function effectively.

### Solution to Problem

One configuration example is a reservoir element including a ring-shaped reservoir constituted by a single nonlinear element and a plurality of delay elements, in which the nonlinear element has a nonlinear modulation function, the nonlinear element being controllable by a time-varying parameter capable of dynamically changing the nonlinear modulation function, and the reservoir element includes a control unit that controls the time-varying parameter in accordance with a time series having a cycle corresponding to the number of stages of the nonlinear element and the delay elements.

### Advantageous Effects of Invention

According to a reservoir element of the present invention, it is possible to improve nonlinear conversion performance of a reservoir and allow the reservoir to function effectively.

### BRIEF DESCRIPTION OF DRAWINGS

FIG. 1 is a diagram illustrating a configuration of a reservoir element according to an embodiment.

FIG. 2 is a diagram illustrating temporal changes in the value of a time-varying parameter of a nonlinear element.

FIG. 3 is a diagram illustrating a configuration of a node according to a first mode example.

FIG. 4 is a diagram illustrating a configuration of a node according to a second mode example.

### DESCRIPTION OF EMBODIMENTS

The present embodiment will be described in detail below with appropriate reference to the drawings.

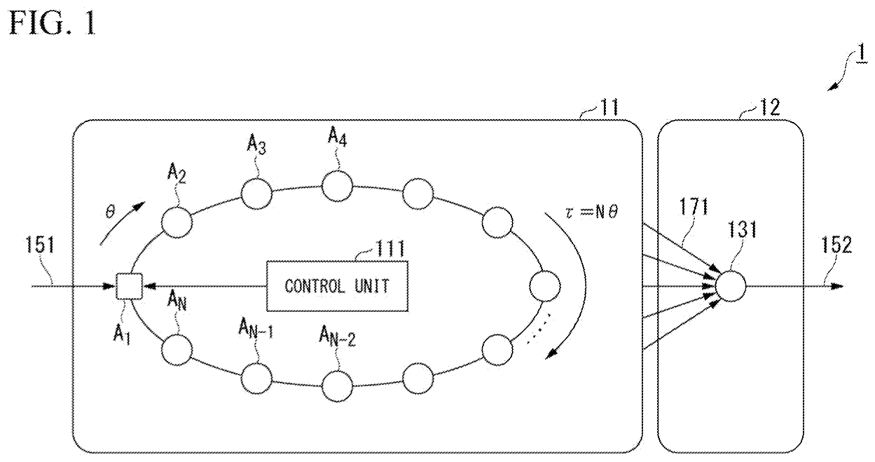

FIG. 1 is a diagram illustrating a configuration of a reservoir element 1 according to an embodiment.

The reservoir element 1 according to the present embodiment is a device that implements processing in reservoir computing. The reservoir computing is an example of a recurrent neural network.

In the present embodiment, a case where the reservoir element 1 is constituted by an analog circuit will be described.

Note that, when the reservoir element 1 is constituted by a digital circuit, the same function as an analog circuit is realized by a digital method.

The reservoir element 1 includes a reservoir 11 and a reading unit 12.

Here, the reservoir element 1 may not include the reading unit 12.

In addition, the reservoir element 1 may include other components.

The reservoir 11 is connected to an input unit 151.

The input unit 151 is a unit that inputs a signal to be processed by the reservoir element 1 to the reservoir 11 from the outside, and may be, for example, a signal line.

The reading unit 12 is connected with an output unit 152.

The output unit 152 is a unit that outputs a signal which is a result of processing performed by the reservoir element 1 to the outside from the reading unit 12, and may be, for example, a signal line.

Note that, for example, the input unit 151 may constitute an input layer of a neural network, and the reading unit 12 and the output unit 152 may constitute an output layer of the neural network. In this case, one or both of the input layer and the output layer may be included in the reservoir element 1.

The reservoir 11 functionally has a node A₁ which is one real node and the nodes A₂ to A_{N} which are (N−1) virtual nodes. In the present embodiment, these nodes may be collectively described as N effective nodes A₁ to A_{N}.

N is an integer of 2 or more.

In addition, the reservoir 11 includes a control unit 111.

The node A₁ which is a single (one) real node is constituted by a nonlinear element. The nonlinear element has a function of performing nonlinear modulation (nonlinear modulation function).

The nodes A₂ to A_{N}, which are (N−1) virtual nodes, are constituted by delay elements. In the present embodiment, the delay element behaves as a virtual nonlinear element.

The node A₁ performs nonlinear transform of a time-series signal input from the input unit 151 in accordance with a parameter controlled by the control unit 111 (referred to as a time-varying parameter in the present embodiment), and outputs the resulting signal.

At this time, the signal already output from the node A₁ is delayed and multiplexed in the signal output from the node A₁. For this reason, the signal resulting from such multiplexing becomes a signal output from the reservoir 11.

Here, the nodes A₂ to A_{N} represent such operation states of the reservoir 11.

The input of a signal, which is output from the node Ai, to the next node Ai is repeated such that a signal output from the node A₁ is input to the next node A₂, and a signal output from the node A₂ is output to the next node A₃. The N effective nodes A₁ to A_{N} are looped (formed in a ring), and a node next after the last node A_{N} is the first node A₁.

Such nodes A₂ to A_{N} have a single delay configuration.

Here, i represents 1 to N. When i exceeds N, it is equivalent to the remainder when divided by N, and for example, i=N+1 is equivalent to i=1.

The control unit 111 controls a time-varying parameter of the nonlinear element constituting the node Aᵢ.

In the present embodiment, the control unit 111 dynamically controls the time-varying parameter of the nonlinear element constituting the node A₁. This control is equivalent to individually controlling the time-varying parameters of the nodes A₂ to A_{N} which are virtual nodes. Thereby, the control unit 111 can provide practical element variations by controlling the time-varying parameter of the nonlinear element constituting the node A₁ in a time-division manner.

Here, any parameter that changes the output from the nonlinear element may be used as the time-varying parameter of the nonlinear element, and one or more of, for example, variable resistance, variable capacitance, the amount of transmission delay of an optical fiber or an optical waveguide, a gain of an amplifier, or an angle of an optical system element such as a mirror, which affects the output from the nonlinear element, may be used.

In addition, as the time-varying parameter of the nonlinear element, for example, one time-varying parameter may be used, or two or more time-varying parameters may be used.

As an example of the nonlinear element, an optical modulation element may be used, and for example, an optical laser, a Micro-Electro-Mechanical System (MEMS) element, a Mach-Zehnder, a spin element such as a spin reservoir element (for example, a reservoir element that uses a spin torque), and the like may be used.

The reading unit 12 includes an adding unit 131 and a connection unit 171.

The adding unit 131 adds a signal output from the reservoir 11.

The connection unit 171 is a portion that connects the reservoir 11 and the adding unit 131, and may be, for example, a signal line.

FIG. 2 is a diagram illustrating temporal changes in the value of a time-varying parameter of a nonlinear element.

In a graph illustrated in FIG. 2, the horizontal axis represents time, and the vertical axis represents the value of the time-varying parameter of the nonlinear element constituting the node A₁.

In the present embodiment, the control unit 111 performs control so that the time-varying parameter of the nonlinear element becomes a control waveform 1011 shown in the graph.

Here, FIG. 2 illustrates the control waveform 1011 for one time-varying parameter, but when two or more time-varying parameters are used, control waveforms for the respective time-varying parameters may be different or may be set arbitrarily.

In the example of FIG. 2, the advance of time per unit time θ is expressed as times t0, t1, t2, . . . .

The control waveform 1011 illustrated in FIG. 2 has N unit times θ as one cycle, and the same waveform is repeated every cycle. In the example of FIG. 2. N=6.

A time τ for one cycle is expressed as τ=Nθ.

Further, in the control waveform 1011, the value of the time-varying parameter can be changed per unit time θ, but there may be portions where the value of the time-varying parameter is the same at two or more adjacent times.

In the present embodiment, the control unit 111 controls the time-varying parameter in a time-division manner so that the value of the time-varying parameter is repeatedly set to be the same value every cycle of the number of stages N(time τ=Nθ).

A nonlinear function representing conversion performed by a nonlinear element is common to the effective nodes A₁ to A_{N}.

The adding unit 131 receives an input of an output signal from one node (one of the N effective nodes A₁ to A_{N}) per unit time θ. The node is switched in the order of the N effective nodes A₁ to A_{N} per unit time θ. The N effective nodes A₁ to A_{N} are looped, and a node next after the last node A_{N} is the first node A₁. Then, the adding unit 131 adds the signals that are input per unit time θ, and outputs the result of the addition (that is, the result of the sum total) for one cycle of the effective nodes A₁ to A_{N}.

As an example, the adding unit 131 may include a memory, store the values of the signals input per unit time θ, calculate the sum of N values, and output the sum.

Here, although the digital control waveform 1011 is shown in the example of FIG. 2, an analog control waveform may be used, or a control waveform such as a sine wave may be used.

The control waveform 1011 may be a variety of waveforms.

### First Mode Example

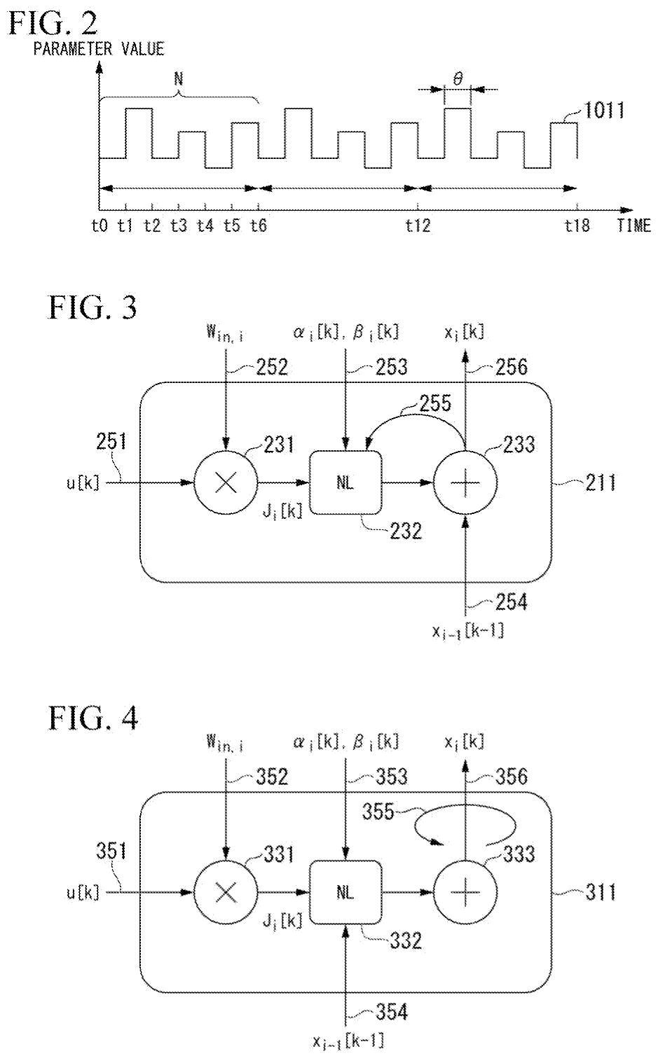

FIG. 3 is a diagram illustrating a configuration of a node 211 according to a first mode example.

The node 211 is a configuration example of each of the effective nodes A₁ to A_{N} illustrated in FIG. 1.

The node 211 includes a multiplication unit 231, a nonlinear function unit 232, and an adding unit 233.

In addition, the node 211 includes an input unit 251, a weight input unit 252, a control input unit 253, a previous node input unit 254, a self-feedback unit 255, and an output unit 256.

Description is given on the assumption that the node 211 is a node Aᵢ.

A state variable of the node A₁ is expressed as xᵢ[k]. The state variable is expressed by an operating equation and is equivalent to a signal output from the node Aᵢ in the present embodiment.

The state variable of each node A₁ is determined for each cycle τ in a time-division manner.

It is assumed that k represents the advance of time, and k is incremented (increased by one) each time the effective nodes A₁ to A_{N} are circulated. k is incremented for each cycle τ with respect to time t in the example of FIG. 2.

The input unit 251 inputs a signal u[k] input to the reservoir 11 to the multiplication unit 231.

The weight input unit 252 inputs a weight w_{in,i} for the input signal u[k]. The weight w_{in,i} may be given depending on, for example, circuit characteristics of the reservoir 11 or may be given by the control unit 111. Note that the weight w_{in,i} may be a fixed value or a variable value. In addition, the weight w_{in,i} may be 1 or 0, that is, there may be substantially no weight w_{in,i}.

Note that the weight may be referred to as a coupling coefficient or the like.

The control input unit 253 inputs time-varying parameters αᵢ[k] and βᵢ[k] to the nonlinear function unit 232. The time-varying parameters αᵢ[k] and βᵢ[k] are given by the control unit 111.

The previous node input unit 254 inputs a signal xᵢ₋₁[k−1] output from the previous node Aᵢ₋₁ to the adding unit 233.

The self-feedback unit 255 inputs a signal output from the adding unit 233 back to the nonlinear function unit 232. This input signal is a signal xᵢ[k−1], which is a time delayed feedback.

The output unit 256 outputs a signal xᵢ[k] output from the adding unit 233 to a next node Aᵢ₊₁.

The multiplication unit 231 multiplies the input signal u[k] by the weight w_{in,i} and outputs a multiplication result Jᵢ[k] to the nonlinear function unit 232.

The nonlinear function unit 232 outputs a signal, which is equivalent to a result of a nonlinear function F_{NL}(xᵢ[k−1]), Jᵢ[k]) for which a result is determined by the input signal Jᵢ[k] from the multiplication unit 231, the time-varying parameters αᵢ[k] and αᵢ[k], and the feedback signal xᵢ[k−1] from the adding unit 233, to the adding unit 233.

In this manner, the nonlinear function unit 232 has a nonlinear modulation function of performing nonlinear modulation using the nonlinear function F_{NL}(xᵢ[k−1], Jᵢ[k].

The adding unit 233 weights and adds the input signal F_{NL}(xᵢ[k−1], Jᵢ[k]) from the nonlinear function unit 232 and the input signal xᵢ₋₁[k−1] from the previous node input unit 254, and outputs a signal xᵢ[k] which is a result of the addition.

Here, the weight given to the signal xᵢ₋₁[k−1] is expressed as a weight &, and the weight given to the signal F_{NL}(xᵢ[k−1], Jᵢ[k]) is expressed as a weight (1−ε). ε may be any value of 0 or more and 1 or less.

The output signal xᵢ[k] from the node Aᵢ is expressed by Formula (1).

The output signal Jᵢ[k] from the multiplication unit 231 is expressed by Formula (2).

[Math. 1]

xᵢ[k]=εxᵢ₋₁[k−1]+(1−ε)F_{NL}(xᵢ[k−1],Jᵢ[k]) (1)

[Math. 2]

Jᵢ[k]=w_{in,i}u[k] (2)

In the present embodiment, the time-varying parameter αᵢ[k] represents a gain, and the time-varying parameter βᵢ[k] represents an offset.

As the nonlinear function F_{NL}(xᵢ[k−1], Jᵢ[k]), for example, a nonlinear activation function using tanh may be used as shown in Formula (3).

[Math. 3]

F_{NL}(xᵢ[k−1],Jᵢ[k])=tanh(αᵢ[k](xᵢ[k−1]+Jᵢ[k])+βᵢ[k]) (3)

As the nonlinear function F_{NL}(xᵢ[k−1], Jᵢ[k]), for example, a nonlinear activation function using ReLu may be used as shown in Formula (4),

[Math. 4]

F_{NL}(xᵢ[k−1],Jᵢ[k])=ReLu(αᵢ[k](xᵢ[k−1]+Jᵢ[k])+βᵢ[k]) (4)

As the nonlinear function F_{NL}(xᵢ[k−1], Jᵢ[k]), for example, a nonlinear activation function using Swish may be used as shown in Formula (5).

Here, the Swish function is expressed using a sigmoid function (standard sigmoid function).

[Math. 5]

F_{NL}(xᵢ[k−1],Jᵢ[k])=Swish(αᵢ[k](xᵢ[k−1]+Jᵢ[k])+βᵢ[k]) (5)

As the nonlinear function F_{NL}(xᵢ[k−1], Jᵢ[k]), for example, a nonlinear activation function using tanh may be used as shown in Formula (6).

[Math. 6]

F_{NL}(xᵢ[k−1],Jᵢ[k])=tanh(αᵢ[k]xᵢ[k−1]+Jᵢ[k]+βᵢ[k]) (6)

As the nonlinear function F_{NL}(xᵢ[k−1], Jᵢ[k]), for example, a nonlinear activation function using ReLu may be used as shown in Formula (7).

[Math. 7]

F_{NL}(xᵢ[k−1],Jᵢ[k])=ReLu(αᵢ[k]xᵢ[k−1]+Jᵢ[k]+βᵢ[k]) (6)

As the nonlinear function F_{NL}(xᵢ[k−1], Jᵢ[k]), for example, a nonlinear activation function using Swish may be used as shown in Formula (8).

[Math. 8]

F_{NL}(xᵢ[k−1],Jᵢ[k])=Swish(αᵢ[k]xᵢ[k−1]+Jᵢ[k]+βᵢ[k]) (8)

Formula (9) shows a relational expression of the time-varying parameter αᵢ[k].

Note that the same applies to the time-varying parameter βᵢ[k].

[Math. 9]

αᵢ[k]=α(τ)=α(iθ+kτ)=α(iθ+kNθ)=α((i+kN)θ) (9)

### Second Mode Example

FIG. 4 is a diagram illustrating a configuration of a node 311 according to a second mode example.

The node 311 is a configuration example of each of the effective nodes A₁ to A_{N} illustrated in FIG. 1.

The node 311 includes a multiplication unit 331, a nonlinear function unit 332, and an adding unit 333.

In addition, the node 311 includes an input unit 351, a weight input unit 352, a control input unit 353, a previous node input unit 354, and a self-feedback unit 355.

Description is given on the assumption that the node 311 is a node Aᵢ.

Denote the state variable of node A₁ as xᵢ[k]. The state variable corresponds to the output signal.

It is assumed that k represents the advance of time, and k is incremented (increased by one) each time the effective nodes A₁ to A_{N} are circulated. k is incremented for each cycle t with respect to time t in the example of FIG. 2.

The functions of the input unit 351, the weight input unit 352, and the multiplication unit 331 are the same as the functions of the input unit 251, the weight input unit 252, and the multiplication unit 231 illustrated in FIG. 3.

The function of the control input unit 353 is the same as the function of the control input unit 253 illustrated in FIG. 3.

The previous node input unit 354 inputs a signal xᵢ₋₁([k−1] output from the previous node Aᵢ₋₁ to the nonlinear function unit 332.

The self-feedback unit 355 inputs a signal output from the adding unit 333 back to the adding unit 333. This input signal is a signal xᵢ[k−1], which is a time delayed feedback.

The function of the output unit 356 is the same as the function of the output unit 256 illustrated in FIG. 3.

The nonlinear function unit 332 outputs a signal, which is equivalent to a result of a nonlinear function F_{NL}(xᵢ₋₁[k−1], Jᵢ[k]) for which a result is determined by the input signal Jᵢ[k] from the multiplication unit 331, the time-varying parameters αᵢ[k] and βᵢ[k], and the input signal xᵢ₋₁[k−1] from the previous node input unit 354, to the adding unit 333.

In this manner, the nonlinear function unit 332 has a nonlinear modulation function of performing nonlinear modulation using the nonlinear function F_{NL}(xᵢ₋₁[k−1], Jᵢ[k]).

The adding unit 333 weights and adds the input signal F_{NL}(xᵢ[k−1], Jᵢ[k]) from the nonlinear function unit 332 and the feedback signal xᵢ[k−1] from itself (adding unit 333), and outputs a signal xᵢ[k] which is a result of the addition.

Here, the weight given to the signal xᵢ[k−1] is expressed as a weight c, and the weight given to the signal F_{NL}(xᵢ₋₁[k−1], Jᵢ[k]) is expressed as a weight (1−ε). ε may be any value of 0 or more and 1 or less.

The output signal xᵢ[k] from the node A₁ is expressed by Formula (10).

[Math. 10]

xᵢ[k]=εxᵢ[k−1]+(1−ε)F_{NL}(xᵢ₋₁[k−1],Jᵢ[k]) (10)

In the present embodiment, the time-varying parameter αᵢ[k] represents a gain and the time-varying parameter βᵢ[k] represents an offset.

As the nonlinear function F_{NL}(xᵢ₋₁[k−1], Jᵢ[k]), for example, a nonlinear activation function using tanh may be used as shown in Formula (11).

[Math. 11]

F_{NL}(xᵢ₋₁[k−1],Jᵢ[k])=tanh(αᵢ[k](xᵢ₋₁[k−1]+Jᵢ[k])+βᵢ[k]) (11)

As the nonlinear function F_{NL}(xᵢ₋₁[k−1], Jᵢ[k]), for example, a nonlinear activation function using ReLu may be used as shown in Formula (12).

[Math. 12]

F_{NL}(xᵢ₋₁[k−1],Jᵢ[k])=ReLu(αᵢ[k](xᵢ₋₁[k−1]+Jᵢ[k])+βᵢ[k]) (12)

As the nonlinear function F_{NL}(xᵢ₋₁[k−1], Jᵢ[k]), for example, a nonlinear activation function using Swish may be used as shown in Formula (13).

[Math. 13]

F_{NL}(xᵢ₋₁[k−1],Jᵢ[k])=Swish(αᵢ[k](xᵢ₋₁[k−1]+Jᵢ[k])+βᵢ[k]) (13)

As the nonlinear function F_{NL}(xᵢ₋₁[k−1], Jᵢ[k]), for example, a nonlinear activation function using tanh may be used as shown in Formula (14).

[Math. 14]

F_{NL}(xᵢ₋₁[k−1],Jᵢ[k])=tanh(αᵢ[k]xᵢ₋₁[k−1]+Jᵢ[k]+βᵢ[k]) (14)

As the nonlinear function F_{NL}(xᵢ₋₁[k−1], Jᵢ[k]), for example, a nonlinear activation function using ReLu may be used as shown in Formula (15).

[Math. 15]

F_{NL}(xᵢ₋₁[k−1],Jᵢ[k])=ReLu(αᵢ[k]xᵢ₋₁[k−1]+Jᵢ[k]+βᵢ[k]) (15)

As the nonlinear function F_{NL}(xᵢ₋₁[k−1], Jᵢ[k]), for example, a nonlinear activation function using Swish may be used as shown in Formula (16).

[Math. 16]

F_{NL}(xᵢ₋₁[k−1],Jᵢ[k])=Swish(αᵢ[k]xᵢ₋₁[k−1]+Jᵢ[k]+βᵢ[k]) (16)

(Time-Varying Parameter Setting Method)

A parameter setting method that can be used as a time-varying parameter setting method according to the present embodiment will be described below.

The parameter setting method according to the present embodiment systematically sets parameters of a portion corresponding to the reservoir 11.

[Ideal Probability Distribution Setting Process]

An ideal output probability distribution of the reservoir element 1 is set. The ideal output probability distribution is arbitrarily set in accordance with a task to be solved by reservoir computing. In addition, the ideal output probability distribution is derived from, for example, a device model. The ideal output probability distribution is determined in accordance with characteristics of the device model. The ideal output probability distribution is, for example, a normal distribution. For example, as a task, a regression problem of approximating an arbitrary Fourier synthetic wave by reservoir computing is considered. At this time, it is desirable that an output frequency distribution of the reservoir element 1 have the same shape as a frequency distribution (equivalent to a power spectrum) included in the Fourier synthetic wave serving as a teacher signal. When the frequency distribution included in the Fourier synthetic wave as the teacher signal is unimodal, it is desirable that the ideal output probability distribution of the reservoir element 1 also be unimodal. Further, when the frequency distribution included in the Fourier synthetic wave as the teacher signal is a bimodal frequency distribution, the ideal output probability distribution of the reservoir element 1 is set to be a mixed normal distribution in order to approximate the bimodal probability distribution.

[Learning Process]

Assuming that parameters for specifying variations are a and b, for example, y=f_{gen}(x)=tanh(ax+b) is a formula including parameters corresponding to the variations in each element. Hereinafter, y=f_{gen}(x)=tanh(ax+b) may be referred to as a first function.

Pre-learning is performed using the first function.

The pre-learning is performed, for example, by simulation. The first function y=f_{gen}(x)=tanh(ax+b) is an extraction of an action that causes nonlinearity of the reservoir element 1. When the pre-learning is performed using the first function, the accuracy of output of the reservoir element 1 can be improved.

The pre-learning is performed such that the amount of mutual information between the ideal output probability distribution and the output probability distribution of the reservoir element 1 (the reservoir element 1 having the first function) is increased. An initial value for the pre-learning can be set arbitrarily, and is set to, for example, a uniform random number of [0:1]. No matter what the initial value of the pre-learning is, a distribution of the parameters a and b is asymptotic to a predetermined distribution by pre-learning. The amount of mutual information is an amount that represents a measure of the mutual interdependence of two probability variables. When the amount of mutual information between the ideal output probability distribution and the output probability distribution of the reservoir element 1 increases, the output probability distribution of the reservoir element 1 approximates to the ideal output probability distribution.

Various amounts of mutual in formation can be used, and for example, the Kullback-Leibler divergence can be used. The Kullback-Leibler divergence is defined as in Formula (17).

$$[ Math . 17 ]$$

$${D}_{KL} ( \tilde{p} , p ) = \int \tilde{p} ( y ) log ( \frac{\tilde{p} ( y )}{p ( y )} ) dy \qquad ( 17 )$$

Here, p^{˜}(y) is the output probability distribution of the reservoir element, and p(y) is the ideal output probability distribution, p(y) is, for example, a normal distribution and expressed by Formula (18). The normal distribution is expressed as a function of a mean σ and a variance μ.

[Math. 18]

$$[ Math . 18 ]$$

$${p}_{norm} ( y ) = \frac{1}{σ \sqrt{2 π}} exp ( - \frac{{( y - μ )}^{2}}{2 {σ}^{2}} ) \qquad ( 18 )$$

When the above-mentioned Kullback-Leibler divergence is differentiated with the parameters a and b, Formulas (19) and (20) are obtained.

$$[ Math . 19 ]$$

$$\frac{\partial {D}_{KL}}{\partial b} = E ( - \frac{μ}{{σ}^{2}} + \frac{y}{{σ}^{2}} ( 2 {σ}^{2} + 1 - {y}^{2} + μ y ) ) \qquad ( 19 )$$

$$[ Math . 20 ]$$

$$\frac{\partial {D}_{KL}}{\partial a} = E ( - \frac{μ x}{{σ}^{2}} + \frac{xy}{{σ}^{2}} ( 2 {σ}^{2} + 1 - {y}^{2} + μ y ) - \frac{1}{a} ) \qquad ( 20 )$$

Learning for increasing the amount of mutual information is performed using, for example, a gradient learning method. The gradient learning method is one of means for obtaining optimum values in machine teaming. A point where the above-mentioned differential value is set to zero corresponds to a portion where an inclination of the Kullback-Leibler divergence with respect to the parameter a or the parameter b is set to zero. Entropy is minimized and the amount of mutual information is maximized in the portion where the inclination is zero. For this reason, when formula transform is performed such that the above-mentioned differential value is set to zero, relational expressions of Formulas (21) and (22) are obtained.

$$[ Math . 17 ]$$

$$Δ a = \frac{η}{a} + Δ bx \qquad ( 21 )$$

$$[ Math . 17 ]$$

$$Δ b = - η ( - \frac{μ}{{σ}^{2}} + \frac{y}{{σ}^{2}} ( 2 {σ}^{2} + 1 - {y}^{2} + μ y ) ) \qquad ( 22 )$$

(Reservoir Element Control Method)

A method of controlling the reservoir element 1 according to the present embodiment includes a step of setting the parameter distribution, a conversion step of converting the parameter distribution into a characteristic distribution of the element, and a step of setting characteristic of each element based on the characteristic distribution.

According to the method of controlling the reservoir element 1 according to the present embodiment, parameters of each element can be systematically set. By systematically setting the parameters based on pre-learning, an output of the reservoir element 1 becomes nonlinear, and the accuracy of matching to teacher data increases.

Here, the accuracy of fitting of the output of the reservoir element 1 to the teacher data varies in accordance with parameter setting of the reservoir element 1. In the present embodiment, it is possible to implement a method of systematically designing parameters for specifying element variations of the plurality of elements constituting the reservoir element 1.

As an example, the parameter setting method according to the present embodiment includes performing pre-learning so that the amount of mutual information between an ideal output probability distribution of the reservoir element 1 derived from a device model based on the characteristics of the plurality of elements constituting the reservoir element 1 and an output probability distribution of the reservoir element 1 increases, and setting a parameter distribution of the parameters for specifying variations of each of the plurality of elements in the device model.

As an example, in the parameter setting method according to the present embodiment, the device model may be a model based on spring vibration.

As an example, in the parameter setting method according to the present embodiment, the device model may be a model based on a generalized nonlinear oscillator model.

As an example, the method of controlling the reservoir element 1 according to the present embodiment includes setting a parameter distribution based on the parameter setting method described above, converting the parameter distribution into a characteristic distribution of the reservoir element 1, and setting characteristics of each of a plurality of elements based on the characteristic distribution.

As an example, in the method of controlling the reservoir element 1 according to the present embodiment, the reservoir element 1 may include a MEMS microphone array having a plurality of MEMS microphones, set a parameter distribution based on the above-described parameter setting method, convert the parameter distribution into a distribution of sensitivity characteristics of the MEMS microphone array, and set sensitivity characteristics of each of the MEMS microphones based on the distribution of sensitivity characteristics.

As an example, in the method of controlling the reservoir element 1 according to the present embodiment, the reservoir element 1 may include a spin torque oscillator array including a plurality of spin torque oscillation elements, set a parameter distribution based on the above-described parameter setting method, convert the parameter distribution into a distribution of resonance characteristics of the spin torque oscillator array, and set frequency characteristics of each of the spin torque oscillation elements based on the distribution of resonance characteristics.

### Regarding Present Embodiment

As described above, in the reservoir element 1 according to the present embodiment, it is possible to improve nonlinear conversion performance of the reservoir 11 and allow the reservoir 11 to function effectively.

In the reservoir element 1 according to the present embodiment, it is possible to adjust an effective network structure of a reservoir device by controlling time-varying parameters of a nonlinear element in a time-division manner. Thereby, in the reservoir element 1 according to the present embodiment, it is possible to provide a control method that enables the ring-shaped reservoir 11 to be mounted and to practically reconfigure the network structure of the reservoir 11.

The reservoir element 1 according to the present embodiment provides a control method of optimizing an effective topology structure by introducing a mechanism for dynamically controlling time-varying parameters of a nonlinear element.

For example, random variations in the time-varying parameters as in Non-Patent Document 3 do not guarantee an improvement in the prediction accuracy of reservoir computing, but in the present embodiment, a theoretical control method for time-varying parameters is realized.

In the reservoir element 1 according to the present embodiment, for example, a coupling topology that is difficult to implement as an integrated electronic device or an optical modulation element can be effectively realized by dynamic time-varying parameter control.

Generally, in an integrated electronic device or the like, wiring becomes a bottleneck in mounting, but the reservoir element 1 according to the present embodiment solves such a problem.

Further, in the reservoir element 1 according to the present embodiment, even when the number of delay elements is increased, it is possible to prevent the rate limiting of an operating speed associated therewith.

In the reservoir element 1 according to the present embodiment, values (parameter sequences) taken by time-varying parameters can be generated, for example, from a time-varying parameter distribution obtained by intrinsic plasticity (IP) learning of a mutual information amount criterion. That is, in the reservoir element 1 according to the present embodiment, it is possible to theoretically determine time-varying parameters of virtual nodes of delayed feedback reservoir computing from results obtained by IP learning of a mutual information amount criterion.

As another example, in the reservoir element 1 according to the present embodiment, a parameter sequence can also be determined by assuming that a time-varying parameter distribution follows a normal distribution, a logarithmic normal distribution, a gamma distribution, or the like.

In the reservoir element 1 according to the present embodiment, a nonlinear element may be mounted as an analog element or as a digital circuit.

Here, in the present embodiment, a case where a time-varying parameter of a nonlinear element is changed per unit time θ is described. However, as another configuration example, a configuration in which a time-varying parameter of a nonlinear element is changed for each integral multiple (for example, 2θ, 3θ, or the like) of a unit time θ may be used.

Further, in the present embodiment, a case where a unit time θ is fixed for all effective nodes A₁ to A_{N} is described. However, as another configuration example, a configuration in which a unit time θ may vary for each of the effective nodes A₁ to A_{N} may be used.

Various modes may be used as a mode for temporally changing parameters, and for example, a mode for temporally changing parameters with a pseudo-random number sequence may be used.

The pseudo-random number sequence may be determined, for example, by IP learning.

The pseudo-random number sequence may be determined, for example, by a logarithmic normal distribution.

For example, an effective network structure of a reservoir device may be a small world structure by IP learning.

For example, parameters that temporally change may be automatically generated from a parametric probability distribution.

### Configuration Example

One configuration example is the reservoir element 1 including the ring-shaped reservoir 11 constituted by a single nonlinear element (node A₁) and a plurality of delay elements (nodes A₂ to A_{N}), in which the nonlinear element has a nonlinear modulation function, the nonlinear element being controllable by a time-varying parameter (for example, time-varying parameters αᵢ[k], βᵢ[k]) capable of dynamically changing the nonlinear modulation function, and the reservoir element 1 includes the control unit Ill that controls the time-varying parameter in accordance with a time series (for example, the control waveform 1011) having a cycle (τ) corresponding to the number of stages (N) of the nonlinear element and the delay elements.

As one configuration example, in the reservoir element 1, the time-varying parameter is set by the time series which is a value variable per unit time (θ).

As one configuration example, in the reservoir element 1, the time-varying parameter is set, by the time series determined by IP learning.

As one configuration example, in the reservoir element 1, the time-varying parameter is set by the time series determined by a logarithmic normal distribution.

As one configuration example, in the reservoir element 1, the nonlinear modulation function is used to perform modulation using a sigmoid as a nonlinear function.

As one configuration example, in the reservoir element 1, the nonlinear modulation function is used to perform modulation using tanh as a nonlinear function.

As one configuration example, in the reservoir element 1, the nonlinear modulation function is used to perform modulation using ReLu as a nonlinear function.

As one configuration example, in the reservoir element 1, the nonlinear modulation function is used to perform modulation using an arbitrary function combined with the nonlinear function. The function may be, for example, a Swish function or a Mish function.

As one configuration example, in the reservoir element 1, the nonlinear element is constituted by a MEMS element.

As one configuration example, in the reservoir element 1, the nonlinear element is constituted by an optical modulation element.

As one configuration example, in the reservoir element 1, the nonlinear element is constituted by a spin element.

In addition, a program for realizing the function of any component in any device as described above may be recorded on a computer-readable recording medium, and the program is read and executed by a computer system. Note that the term “computer system” as used herein includes an operating system or hardware such as peripheral devices. In addition, the “computer-readable recording medium” means portable media such as a flexible disk, a magneto-optical disc, a read only memory (ROM), a compact disc (CD)-ROM, and a storage device such as a hard disk built into a computer system. Further, it is assumed that the “computer-readable recording medium” also includes a medium that holds a program for a fixed period of time such as a volatile memory inside the computer system serving, as a server or a client in a case where the program is transmitted through a network such as the Internet. or a communication line such as a telephone line. The volatile memory may be, for example, a random-access memory (RAM). The recording medium may be, for example, a non-transitory recording medium.

In addition, the above-described program may be transmitted from a computer system storing this program in a storage device or the like to another computer system via a transmission medium or by transmitted waves in the transmission medium. Here, the “transmission medium” transmitting the program refers to a medium having a function of transmitting information like a network such as the Internet or a communication line such as a telephone line.

In addition, the above-described program may be a program for realizing some of the above-described functions. Further, the above-described program may be a so-called differential file capable of realizing the above-described function in combination with a program which is recorded in advance in the computer system. The differential file may be referred to as a differential program.

In addition, the functions of any components in any device as described above may be implemented by a processor. For example, each processing in the embodiment may be implemented by a processor that operates based on information such as a program and a computer-readable recording medium that stores information such as the program. Here, for the processor, for example, the function of each unit may be implemented by separate hardware, or the function of each unit may be implemented by integrated hardware. For example, the processor includes hardware, which may include at least one of circuitry that processes digital signals and circuitry that processes analog signals. For example, the processor may be constituted by either one or both of one or a plurality of circuit devices or one or a plurality of circuit elements mounted on a circuit board. An integrated circuit (IC) or the like may be used as the circuit device, and a resistor, a capacitor, or the like may be used as the circuit element.

Here, the processor may be, for example, a CPU. However, the processor is not limited to a CPU, and various processors such as a graphics processing unit (GPU) or a digital signal processor (DSP) may be used. In addition, the processor may be, for example, a hardware circuit based on an application specific integrated circuit (ASIC). In addition, the processor may be constituted by, for example, a plurality of CPUs, or may be constituted by a hardware circuit based on a plurality of ASICs. In addition, the processor may be constituted by, for example, a combination of a plurality of CPUs and a hardware circuit based on a plurality of ASICs. The processor may also include, for example, one or more of amplifier circuits, filter circuits, or the like that process analog signals.

Although the embodiment of the present invention has been described in detail with reference to the drawings, the specific configuration is not limited to this embodiment, and design and the like are included within the scope of the gist of the present invention.

### REFERENCE SIGNS LIST

1 Reservoir element
11 Reservoir
12 Reading unit
11 Control unit
131 Adding unit
151, 251, 351 input unit
152, 256, 356 Output unit
171 Connection unit
211, 311 Node
231, 331 Multiplication unit
232, 332 Nonlinear function unit
233, 333 Adding unit
252, 352 Weight input unit
253, 353 Control input unit
254, 354 Previous node input unit
255, 355 Self-feedback unit
1011 Control waveform
A₁ Node (real node)
A₂ to A_{N} Node (virtual nodes)

1. A reservoir element comprising:
a ring-shaped reservoir constituted by a single nonlinear element and a plurality of delay elements,
wherein the nonlinear element has a nonlinear modulation function, the nonlinear element being controllable by a time-varying parameter capable of dynamically changing the nonlinear modulation function,
the time-varying parameter is configured to perform a modulation of a state variable of the nonlinear element or a modulation of a state variable of the delay element which is one before the nonlinear element in the ring-shaped reservoir, and
the reservoir element includes a control unit that is configured to control the time-varying parameter in accordance with a time series having a cycle corresponding to the number of stages of the nonlinear element and the delay elements.

2. The reservoir element according to claim 1, wherein the time-varying parameter is set by the time series which is a value variable per unit time.

3. The reservoir element according to claim 1, wherein the time-varying parameter is set by the time series determined by IP learning.

4. The reservoir element according to claim 1, wherein the time-varying parameter is set by the time series determined by a logarithmic normal distribution.

5. The reservoir element according to claim 1, wherein the nonlinear modulation function is used to perform modulation using a sigmoid as a nonlinear function.

6. The reservoir element according to claim 1, wherein the nonlinear modulation function is used to perform modulation using tanh as a nonlinear function.

7. The reservoir element according to claim 1, wherein the nonlinear modulation function is used to perform modulation using ReLu as a nonlinear function.

8. The reservoir element according to claim 5, wherein the nonlinear modulation function is used to perform modulation using an arbitrary function combined with the nonlinear function.

9. The reservoir element according to claim 1, wherein the nonlinear element is constituted by a MEMS element.

10. The reservoir element according to claim 1, wherein the nonlinear element is constituted by an optical modulation element.

11. The reservoir element according to claim 1, wherein the nonlinear element is constituted by a spin element.

12. The reservoir element according to claim 6, wherein the nonlinear modulation function is used to perform modulation using an arbitrary function combined with the nonlinear function.

13. The reservoir element according to claim 7, wherein the nonlinear modulation function is used to perform modulation using an arbitrary function combined with the nonlinear function.
